(19) United States
(12) Patent Application Publication
(10) Pub. No.: US 2025/0380071 A1
(43) Pub. Date: Dec. 11, 2025

(54) DISPLAY DEVICE AND ELECTRONIC DEVICE INCLUDING THE SAME

(71) Applicant: Samsung Display Co., LTD., Yongin-si (KR)

(72) Inventors: Tae Sung KIM, Yongin-si (KR); Koichi ABE, Yongin-si (KR); Ga Mi LEE, Yongin-si (KR)

(73) Assignee: Samsung Display Co., LTD., Yongin-si (KR)

(21) Appl. No.: 19/012,372

(22) Filed: Jan. 7, 2025

(30) Foreign Application Priority Data
Jun. 5, 2024 (KR) 10-2024-0073692

(51) Int. Cl. H04R 1/02

(52) U.S. Cl. CPC H04R 1/025; H04R 1/028; H04R 2499/11; H04R 2499/15

(57) ABSTRACT

A display device includes a display panel, a sound generating device disposed on a rear surface of the display panel, a chassis disposed on the rear surface of the display panel and including an opening, and a baffle disposed between the display panel and the chassis and including an exhaust portion. The exhaust portion extends toward the opening.

### CROSS-REFERENCE TO RELATED APPLICATION(S)

This application claims priority to and benefits of Korean patent application No. 10-2024-0073692 under 35 U.S.C. § 119 (a), filed on Jun. 5, 2024, in the Korean Intellectual Property Office (KIPO), the entire contents of which are incorporated herein by reference.

### BACKGROUND

### 1. Technical Field

The disclosure generally relates to a display device and an electronic device including the same.

### 2. Description of the Related Art

Recently, as interest in information displays is increased, research and development of display devices have been continuously conducted.

### SUMMARY

Embodiments provide a display device capable of improving sound characteristics.

In accordance with an embodiment of the disclosure, a display device may include a display panel, a sound generating device disposed on a rear surface of the display panel, a chassis disposed on the rear surface of the display panel and including an opening, and a baffle disposed between the display panel and the chassis and including an exhaust portion. The exhaust portion may extend toward the opening.

The baffle may surround the sound generating device in a plan view.

The sound generating device may include a first sound generating device and a second sound generating device, which are spaced apart from each other in a plan view.

The opening may be disposed between the first sound generating device and the second sound generating device in a plan view.

The baffle may include a first side extending in a first direction and a second side extending in a second direction intersecting the first direction in a plan view.

The exhaust portion may extend in the second direction from the first side in a plan view.

The exhaust portion may include a first exhaust portion disposed at a first corner of the baffle at which the first side and the second side intersect each other in a plan view.

The opening may include a first opening adjacent to the first exhaust portion.

The baffle may further include a third side facing the first side in a plan view. The exhaust portion may further include a second exhaust portion disposed at a second corner of the baffle at which the second side and the third side intersect each other in a plan view.

The opening may include a second opening adjacent to the second exhaust portion.

In accordance with an embodiment of the disclosure, a display device may include a display panel, a sound generating device disposed on a rear surface of the display panel, a chassis disposed on the rear surface of the display panel and including an opening, and a baffle disposed between the display panel and the chassis. The baffle may include a first area surrounding the sound generating device in a plan view and a second area extending toward the opening from the first area.

A length of the first area may be greater than a length of the second area in an extension direction of the second area.

The first area may include a first side extending in a first direction and a second side extending in a second direction intersecting the first direction in a plan view.

The second area may extend in the second direction from the first side in a plan view.

The second area may include a first exhaust portion extending from a first corner of the first area at which the first side and the second side intersect each other in a plan view.

The first exhaust portion may extend in a third direction intersecting the first direction and the second direction in a plan view.

The first area may further include a third side facing the first side in a plan view. The second area may further include a second exhaust portion extending from a second corner of the first area at which the second side and the third side intersect each other in a plan view.

The second exhaust portion may extend in a fourth direction intersecting the first direction and the second direction in a plan view.

The sound generating device may include a first sound generating device and a second sound generating device, which are spaced apart from each other in a plan view.

The opening may be disposed between the first sound generating device and the second sound generating device in a plan view.

In accordance with an embodiment of the disclosure, an electronic device may include a processor to provide input image data, and a display device to display an image based on the input image data, the display device including sub-pixel areas, wherein the display device comprises a display panel, a sound generating device disposed on a rear surface of the display panel, a chassis disposed on the rear surface of the display panel and including an opening, and a baffle disposed between the display panel and the chassis and including an exhaust portion, wherein the exhaust portion extends toward the opening.

### BRIEF DESCRIPTION OF THE DRAWINGS

Embodiments will now be described more fully hereinafter with reference to the accompanying drawings; however, they may be embodied in different forms and should not be construed as limited to the embodiments set forth herein. Rather, these embodiments are provided so that this disclosure will be more thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view illustrating a display device in accordance with an embodiment of the disclosure.

FIG. 2 is a plan view illustrating the display device in accordance with an embodiment of the disclosure.

FIG. 3 is a schematic cross-sectional view taken along line A-A′ shown in FIG. 2.

FIG. 4 is a schematic cross-sectional view illustrating a sound generating device in accordance with an embodiment of the disclosure.

FIGS. 5 and 6 are schematic cross-sectional views illustrating a sound generating method of the display device in accordance with an embodiment of the disclosure.

FIG. 7 is a plan view illustrating a display device in accordance with an embodiment of the disclosure.

FIG. 8 is a schematic cross-sectional view taken along line B-B′ shown in FIG. 7.

FIG. 9 is a plan view illustrating a display device in accordance with an embodiment of the disclosure.

FIG. 10 is a schematic cross-sectional view taken along line C-C′ shown in FIG. 9.

FIG. 11 is a schematic block diagram illustrating an electronic device including a display device in accordance with an embodiment.

FIG. 12 is a schematic diagram illustrating an example where the electronic device of FIG. 11 is a smartphone.

FIG. 13 is a schematic diagram illustrating an example where the electronic device of FIG. 11 is a tablet computer.

### DETAILED DESCRIPTION OF THE EMBODIMENTS

Hereinafter, embodiments of the disclosure will be described in more detail with reference to the accompanying drawings. In the description below, only a necessary part to understand an operation according to the disclosure is described and the descriptions of other parts are omitted in order not to unnecessarily obscure subject matters of the disclosure. In addition, the disclosure is not limited to embodiments described herein, but may be embodied in various different forms. Rather, embodiments described herein are provided to thoroughly and completely describe the disclosed contents and to sufficiently transfer the ideas of the disclosure to a person of ordinary skill in the art.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element. The technical terms used herein are used only for the purpose of illustrating a specific embodiment and not intended to limit the embodiment.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

In addition, the embodiments of the disclosure are described here with reference to schematic diagrams of embodiments (and an intermediate structure) of the disclosure, so that changes in a shape as shown due to, for example, manufacturing technology and/or a tolerance may be expected. Therefore, the embodiments of the disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

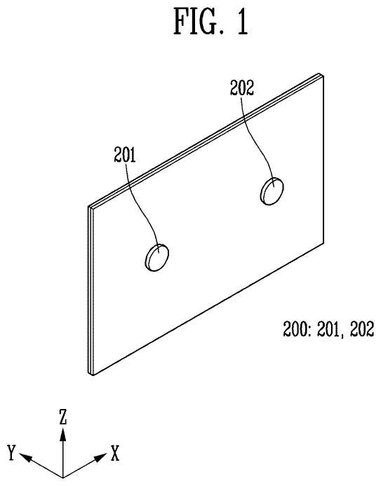

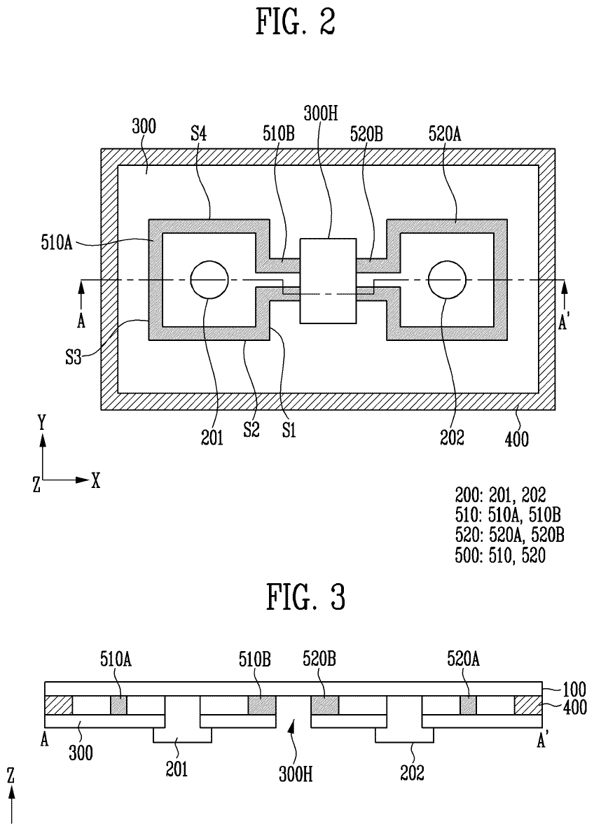

FIG. 1 is a perspective view illustrating a display device in accordance with an embodiment of the disclosure. FIG. 2 is a plan view illustrating the display device in accordance with an embodiment of the disclosure. FIG. 3 is a schematic cross-sectional view taken along line A-A′ shown in FIG. 2.

Referring to FIGS. 1 to 3, the display device in accordance with the embodiment of the disclosure may include a display panel 100, a sound generating device 200, a chassis 300, an adhesive member 400, and/or a baffle 500.

The display panel 100 may display an image and be vibrated by the sound generating device 200 disposed on a rear surface of the display panel 100. The display panel 100 may be various types of display panels such as a liquid crystal display panel, an organic light emitting display panel, a plasma display panel, a quantum dot light emitting display panel, a micro light emitting diode display panel, and/or an electrophoretic display panel, and be variously selected within a range in which display panels are vibrated by the sound generating device 200 to generate sound waves.

For example, in case that the display panel 100 is a liquid crystal display panel, the display panel 100 may include a lower substrate (or thin film transistor array substrate) including pixels defined by gate lines and data lines, and a thin film transistor for driving each pixel, an upper substrate (or color filter array substrate) including a color filter and/or a black matrix, and a liquid crystal layer for adjusting a light transmittance according to driving of each pixel.

In case that the display panel 100 is an organic light emitting display panel, the display panel 100 may include a thin film transistor array substrate including pixels defined by gate lines and data lines, and a thin film transistor provided in each pixel to drive each pixel, an organic light emitting element layer disposed on the thin film transistor array substrate, an encapsulation substrate covering the organic light emitting element layer, and the like.

The sound generating device 200 may be disposed on the rear surface of the display panel 100. The sound generating device 200 may generate a sound by directly vibrating the display panel 100. The sound generating device 200 may be fixed to the chassis 300. For example, the sound generating device 200 may be implemented as an actuator, an exciter, a transducer, or the like, but the disclosure is not necessarily limited thereto.

The sound generating device 200 may include a first sound generating device 201 and a second sound generating device 202. The first sound generating device 201 and the second sound generating device 202 may be spaced apart from each other in a plan view. The first sound generating device 201 may be disposed in an area (or left area) of the display panel 100, and the second sound generating device 202 may be disposed in another area (or right area) of the display panel 100. The first sound generating device 201 and the second sound generating device 202 may output sounds in different sound ranges, and output a stereo sound caused by left/right sound separation. However, the disclosure is not necessarily limited.

Although an embodiment in which the sound generating device 200 is configured with two sound generating devices is illustrated in the drawings, the disclosure is not necessarily limited. In some embodiments, the sound generating device 200 may be configured with one or three or more sound generating devices.

The chassis 300 may be disposed on the rear surface of the display panel 100 and/or a rear surface of the sound generating device 200. The chassis 300 may support at least one of the rear surface or side surfaces of the display panel 100. The chassis 300 may support or fix the sound generating device 200 disposed on the rear surface of the display panel 100. For example, the chassis 300 may be a plate-shaped member made of a metal material, a glass material, or a plastic material, which is formed throughout the rear surface or the whole of the display panel 100.

In an embodiment, the chassis 300 may include an opening 300H. As air between the display panel 100 and the chassis 300 is exhausted to the outside through the opening 300H of the chassis 300, damping may be controlled, thereby improving sound characteristics of the display device. For example, air between the display panel 100 and the chassis 300 may be compressed by an operation of the sound generating device 200. The compressed air may be guided by the baffle 500 to be exhausted to the outside through the opening 300H of the chassis 300. In an embodiment, the opening 300H of the chassis 300 may be disposed between the first sound generating device 201 and the second sound generating device 202 in a plan view.

The adhesive member 400 may be disposed between the display panel 100 and the chassis 300 to couple the display panel 100 and the chassis 300 to each other. The adhesive member 400 may be disposed between an edge of the display panel 100 and an edge of the chassis 300. For example, the adhesive member 400 may be implemented as a double-sided tape or a double-side adhesive foam pad, but the disclosure is not limited thereto.

The baffle 500 may be disposed between the display panel 100 and the chassis 300. The baffle 500 may at least partially surround the sound generating device 200 in a plan view. The baffle 500 may block a sound from being leaked to the outside through each side surface such that the sound may be output in a front direction of the display panel 100. Accordingly, sound output characteristics of the display device may be improved.

The baffle 500 may be formed of a polyurethane or polyolefin material, but the disclosure is not necessarily limited thereto. For example, the baffle 500 may be implemented as a single-sided tape, a double-side tape, or the like, or be implemented with a material having an elasticity with which the material can be compressed to a degree.

The baffle 500 may include a first baffle 510 and a second baffle 520. The first baffle 510 and the second baffle 520 may be spaced apart from each other in a plan view. The first baffle 510 may at least partially surround the first sound generating device 201 in a plan view. The second baffle 520 may at least partially surround the second sound generating device 202 in a plan view.

The first baffle 510 and the second baffle 520 may separate left/right sounds generated in the first sound generating device 201 and the second sound generating device 202, respectively. Since each of the first baffle 510 and the second baffle 520 attenuates or absorb vibrations of the display panel 100 at the center of the display panel 100, the first baffle 510 and the second baffle 520 may block a sound of the left area from being transferred to the right area or block a sound of the right area from being transferred to the left area. Thus, the first baffle 510 and the second baffle 520 may separate left/right sounds, respectively, thereby improving the sound output characteristics and improving stereo characteristics of sounds.

The first baffle 510 may include a first area 510A surrounding the first sound generating device 201 in a plan view and a second area 510B (or exhaust portion) extending toward the opening 300H of the chassis 300 from the first area 510A.

The second baffle 520 may include a first area 520A surrounding the second sound generating device 202 in a plan view and a second area 520B (or exhaust portion) extending toward the opening 300H of the chassis 300 from the first area 520A.

A space surrounded by the first area 510A or 520A may correspond to a space in which a sound is generated in case that the display panel 100 is vibrated by the sound generating device 200.

The second area 510B or 520B may extend toward the opening 300H of the chassis 300. The second area 510B or 520B may provide a path through which air between the display panel 100 and the chassis 300 may move to the opening 300H of the chassis 300. For example, air between the display panel 100 and the chassis 300 may be compressed by an operation of the sound generating device 200, and the compressed air may be guided to the opening 300H of the chassis 300 through the second area 510B or 520B of the baffle 500. Accordingly, the air between the display panel 100 and the chassis 300 may be exhausted to the outside through the opening 300H of the chassis 300, to control damping, thereby improving the sound characteristics of the display device.

Each of the first areas 510A and 520A may include first to fourth sides S1, S2, S3, and S4. The first side S1 may extend in a second direction (Y-axis direction) in a plan view. The second side S2 may extend in a first direction (X-axis direction) intersecting the second direction (Y-axis direction) in a plan view. The third side S3 may face the first side S1 in a plan view. The third side S3 may extend in the second direction (Y-axis direction). The fourth side S4 may face the second side S2 in a plan view. The fourth side S4 may extend in the first direction (X-axis direction).

The second area 510B or 520B may extend toward the opening 300H of the chassis 300 from the first side S1 in a plan view. For example, the second area 510B or 520B may extend in the first direction (X-axis direction) or the opposite direction of the first direction (X-axis direction) from the first side S1 in a plan view.

In an embodiment, a length of the first area 510A or 520A in the first direction (X-axis direction) may be greater than a length of the second area 510B or 520B in the first direction (X-axis direction). For example, a length of the second side S2 of the first area 510A or 520A in the first direction (X-axis direction), and/or a length of the fourth side S4 of the first area 510A or 520A in the first direction (X-axis direction) may be greater than the length of the second area 510B or 520B in the first direction (X-axis direction). A width of the first area 510A and 520A in the second direction (Y-axis direction) may be greater than a distance between the second areas 510B and 520B in the second direction (Y-axis direction). For example, a length of the first side S1 of the first area 510A or 520A in the second direction (Y-axis direction) and/or a length of the third side S3 of the first area 510A or 520A in the second direction (Y-axis direction) may be greater than the distance between the second areas 510B and 520B in the second direction (Y-axis direction).

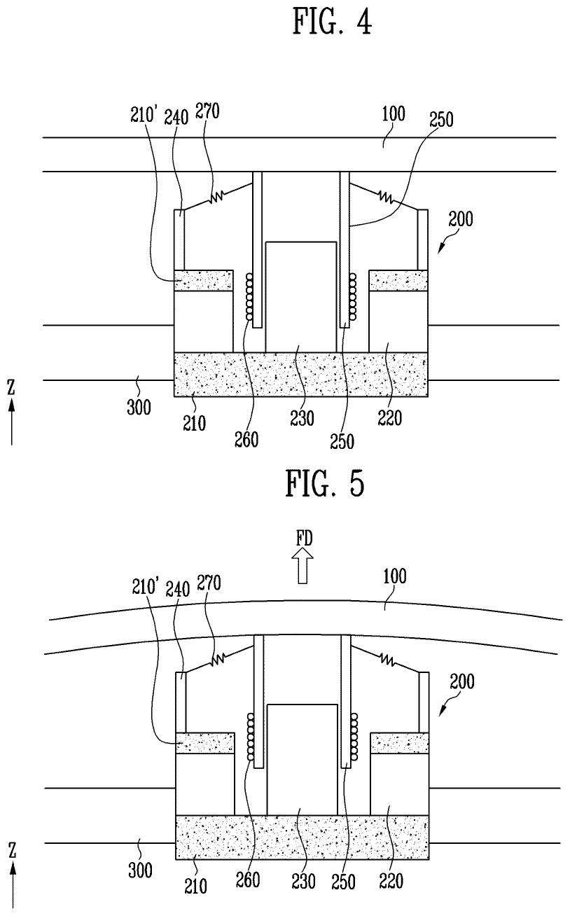

FIG. 4 is a schematic cross-sectional view illustrating a sound generating device in accordance with an embodiment of the disclosure.

Referring to FIG. 4, the sound generating device 200 may include first and second module frames 210 and 210′, a magnet member 220, a center pole 230, an external frame 240, a bobbin 250, a coil 260, and/or a damper 270.

The first module frame 210 may be disposed at a lower end of the sound generating device 200 to serve as a base. The second module frame 210′ may be disposed on the magnet member 220 disposed on the first module frame 210. For example, the second module frame 210′ may be spaced apart from the first module frame 210 with the magnet member 220 interposed between the second module frame 210′ and the first module frame 210.

The first module frame 210 and the second module frame 210′ may fix the sound generating device 200 to the chassis 300 while supporting the magnet member 220. Therefore, the first module frame 210 may be fixed to a support hole provided in the chassis 300, and the magnet member 220 may be fixed and supported between the first module frame 210 and the second module frame 210′.

The magnet member 220 may be disposed on the first module frame 210. The magnet member 220 may be disposed along an edge of the first module frame 210. The magnet member 220 may surround the center pole 230 in a plan view. The magnet member 220 may be spaced apart from the center pole 230.

The center pole 230 may be disposed on the first module frame 210. The center pole 230 may be disposed at the center of the first module frame 210. The center pole 230 may be surrounded by the second module frame 210′ and the magnet member 220 in a plan view. The center pole 230 may be spaced apart from the second module frame 210′ and the magnet member 220. The center pole 230 may be surrounded by the bobbin 250 in a plan view. The center pole 230 may be spaced apart from the bobbin 250. The bobbin 250 may be disposed between the center pole 230, and the second module frame 210′ and the magnet member 220. The bobbin 250 may be spaced apart from the second module frame 210′ and the magnet member 220.

The center pole 230 may guide a vertical reciprocating motion of the bobbin 250. For example, the center pole 230 may be formed at an appropriate height at which the vertical reciprocating motion of the bobbin 250 may be guided. In an embodiment, the center pole 230 and the first module frame 210 may be integral with each other, but the disclosure is not necessarily limited thereto.

The external frame 240 may extend toward the display panel 100 from an edge of a top surface of the second module frame 210′. An upper portion of the external frame 240 may be connected to the damper 270. In an embodiment, the external frame 240 may be a portion of the second module frame 210′, and the external frame 240 and the second module frame 210′ may be integral with each other. However, the disclosure is not necessarily limited thereto.

The bobbin 250 may surround at least a portion of the center pole 230 in a plan view. For example, the bobbin 250 may be implemented in a cylindrical shape having a hollow portion in which the center pole 230 can be accommodated. The bobbin 250 may be implemented in an annular (or cylindrical) structure formed of a material obtained by processing pulp or paper, aluminum, magnesium, or an alloy thereof, a synthetic resin including polypropylene, a polyamide-based fabric, or the like. The bobbin 250 may perform a vertical reciprocating motion by means of a magnetic force.

The coil 260 may be wound around a lower outer surface of the bobbin 250. The coil 260 may receive a current (or voice signal) for generating a sound supplied from the outside. The coil 260 may be wound around the bobbin 250 to be implemented as a voice coil. In case that a current is applied to the coil 260, a magnetic field may be formed around the coil 260, and the entire bobbin 250 may perform a vertical reciprocating motion by means of the magnetic field formed by the magnet member 220 while being guided by the center pole 230. The vertical reciprocating motion of the bobbin 250 may vibrate the display panel 100, and sound waves may be generated by the vibration of the display panel 100, so that a sound may be output in the front direction of the display panel 100.

The damper 270 may connect the upper portion of the external frame 240 to an upper portion of the bobbin 250. In an embodiment, the damper 270 may be implemented in a wrinkled structure and have an elasticity. The damper 270 may control vertical vibration of the bobbin 250 while being contracted and relaxed along the reciprocating motion of the bobbin 250. For example, the vertical vibration of the bobbin 250 may be controlled by a restoring force of the damper 270. In case that the bobbin 250 vibrates over or below a certain height, the bobbin 250 may be returned to the original position by the restoring force of the damper 270.

However, the sound generating device 200 of the disclosure is not limited to the structure shown in FIG. 4, and may be implemented in various forms in which a sound can be generated by vibrating the display panel 100.

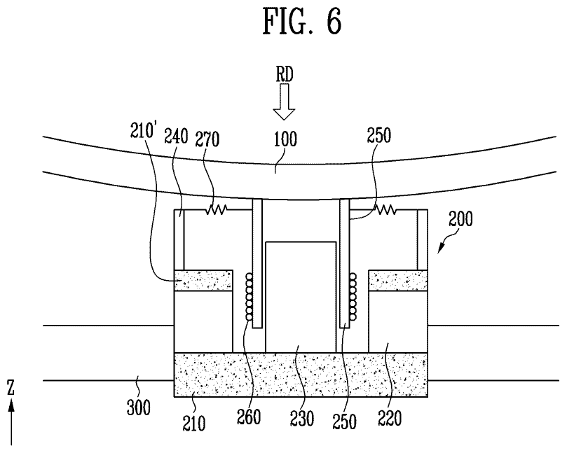

FIGS. 5 and 6 are schematic cross-sectional views illustrating a sound generating method of the display device in accordance with an embodiment of the disclosure.

Referring to FIG. 5, in case that a current for sound generation is applied to the coil 260, the center pole 230 may be magnetized to an N pole and the second module frame 210′ may be magnetized to an S pole, and an external magnetic field may be formed inside the coil 260 (or a space in which the center pole 230 is disposed). As the center pole 230 is integrally formed with the first module frame 210 connected to a bottom surface of the magnet member 220, the center pole 230 may be magnetized to the S pole.

In case that the current for sound generation is applied to the coil 260, an applied magnetic field may be generated around the coil 260, and the bobbin 250 may be moved in a front direction FD of the display panel 100 by a force generated from the applied magnetic field and the external magnetic field. For example, since, in case that the current is applied to the coil 260, the applied magnetic field is formed around the coil 260 and the external magnetic field is formed inside the coil 260 by the magnet member 220, the entire bobbin 250 may be guided by the center pole 230 to be moved in the front direction FD of the display panel 100.

Since an end of the bobbin 250 is in contact with the rear surface of the display panel 110, the bobbin 250 may vibrate the display panel 100 in the front direction FD according to a state in which the current is applied to the coil 260 or a state in which the current is not applied to the coil 250, and sound waves (or a sound) generated by the vibration of the display panel 100 may be generated.

Referring to FIG. 6, in case that the application of the current, which allows the bobbin 250 to vibrate upwardly, is suspended or in case that the current is applied in the opposite direction, a force for moving the bobbin 250 in a rear direction RD of the display panel 100 may be generated according to the principle described in FIG. 5, the display panel 100 may vibrate in the rear direction RD according to the movement of the bobbin 250, and sound waves (or a sound) may be generated by the vibration of the display panel 100.

Therefore, the display panel 100 may vibrate in the front direction FD or the rear direction RD according to a direction and a magnitude of the current applied to the coil 260, and sound waves (or a sound) generated according to the vibration of the display panel 100 may be output in the front direction FD of the display panel 100.

The display device in accordance with the above-described embodiment may include the sound generating device 200 which generates a sound by vibrating the display panel 100, so that the sound may be output in the front direction of the display panel 100. Accordingly, the immersion of a viewer watching an image may be enhanced.

Moreover, although air between the display panel 100 and the chassis 300 is compressed due to an operation of the sound generating device 200 in case that a sound is output, the compressed air may be guided to the opening 300H of the chassis 300 through the baffle 500. Accordingly, the air between the display panel 100 and the chassis 300 may be exhausted to the outside through the opening 300H of the chassis 300, to control damping, thereby improving the sound characteristics of the display device.

Hereinafter, another embodiment will be described. In the following embodiment, components identical to the already described components are designated by like reference numerals, and overlapping descriptions will be omitted or simplified.

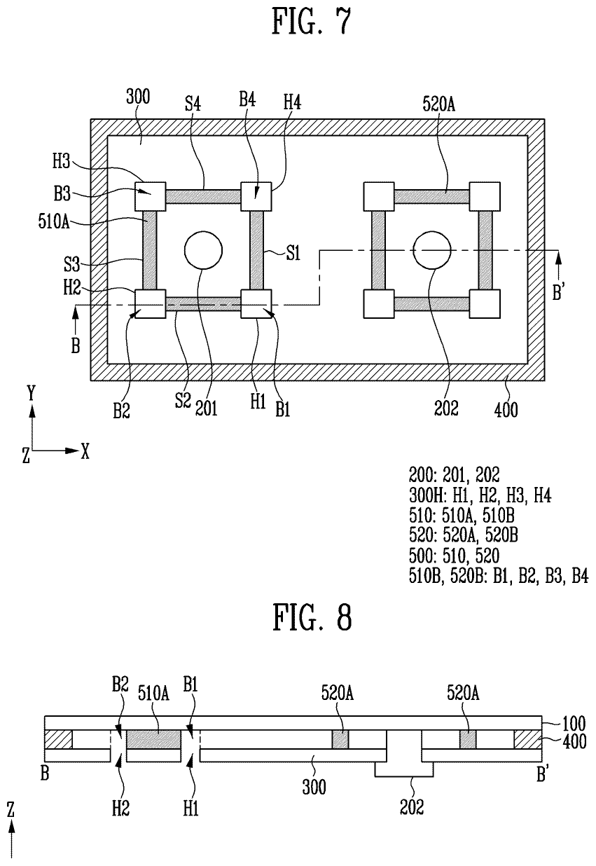

FIG. 7 is a plan view illustrating a display device in accordance with an embodiment of the disclosure. FIG. 8 is a schematic cross-sectional view taken along line B-B′ shown in FIG. 7.

Referring to FIGS. 7 and 8, in accordance with the embodiment of the disclosure, a second area 510B or 520B (or exhaust portion) of a baffle 500 and/or an opening 300H of a chassis 300 may be provided in plurality.

The second area 510B or 520B of the baffle 500 may include first to fourth exhaust portions B1, B2, B3, and B4. The first exhaust portion B1 may be disposed at a first corner between a first side S1 and a second side of a first area 510A or 510B of the baffle 500 in a plan view. The first corner may be a point at which the first side SI and the second side S2 intersect each other in a plan view. In an embodiment, the first exhaust portion B1 may have a hole shape formed at the first corner.

The second exhaust portion B2 may be disposed at a second corner between the second side S2 and a third side S3 of the first area 510A or 520A in a plan view. The second corner may be a point at which the second side S2 and the third side S3 intersect each other in a plan view. In an embodiment, the second exhaust portion B2 may have a hole shape formed at the second corner.

The third exhaust portion B3 may be disposed at a third corner between the third side S3 and a fourth side S4 of the first area 510A or 520A in a plan view. The third corner may be a point at which the third side S3 and the fourth side S4 intersect each other in a plan view. In an embodiment, the third exhaust portion B3 may have a hole shape formed at the third corner.

The fourth exhaust portion B4 may be disposed at a fourth corner between the fourth side S4 and the first side S1 of the first area 510A or 520A in a plan view. The fourth corner may be a point at which the fourth side S4 and the first side S1 intersect each other in a plan view. In an embodiment, the fourth exhaust portion B4 may have a hole shape formed at the fourth corner.

The opening 300H of the chassis 300 may include first to fourth openings H1, H2, H3, and H4.

The first opening H1 may overlap the first corner between the first side S1 and the second side S2 of the first area 510A or 520A in a plan view. The first corner may be the point at which the first side S1 and the second side S2 intersect each other in a plan view. The first opening H1 may be adjacent to the first exhaust portion B1 in a plan view. The first opening H1 may overlap the first exhaust portion B1 in a plan view.

The second opening H2 may overlap the second corner between the second side S2 and the third side S3 of the first area 510A or 520A in a plan view. The second corner may be the point at which the second side S2 and the third side S3 intersect each other in a plan view. The second opening H2 may be adjacent to the second exhaust portion B2 in a plan view. The second opening H2 may overlap the second exhaust portion B2 in a plan view.

The third opening H3 may overlap the third corner between the third side S3 and the fourth side S4 of the first area 510A or 520A in a plan view. The third corner may be the point at which the third side S3 and the fourth side S4 intersect each other in a plan view. The third opening H3 may be adjacent to the third exhaust portion B3 in a plan view. The third opening H3 may overlap the third exhaust portion B3 in a plan view.

The fourth opening H4 may overlap the fourth corner between the fourth side S4 and the first side S1 of the first area 510A or 520A in a plan view. The fourth corner may be the point at which the fourth side S4 and the first side S1 intersect each other in a plan view. The third opening H3 may be adjacent to the fourth exhaust portion B4 in a plan view. The third opening H3 may overlap the fourth exhaust portion B4 in a plan view.

Although an embodiment in which the second area 510B or 520B (or exhaust portion) of the baffle 500 and/or the opening 300H of the chassis 300 are/is configured with four exhaust portions and/or four openings is illustrated in FIGS. 7 and 8, the disclosure is not necessarily limited thereto, and the number, position, size, and the like of the second area 510B or 520B (or exhaust portion) of the baffle 500 and/or the opening 300H of the chassis 300 may be variously changed.

In the display device in accordance with the above-described embodiment, the second area 510B or 520B (or exhaust portion) of the baffle 500 and/or the opening 300H of the chassis 300 are/is provided in plurality, and the position and size thereof may be adjusted by considering a sound, a device structure, and the like, so that damping can be readily controlled, thereby improving sound characteristics of the display device.

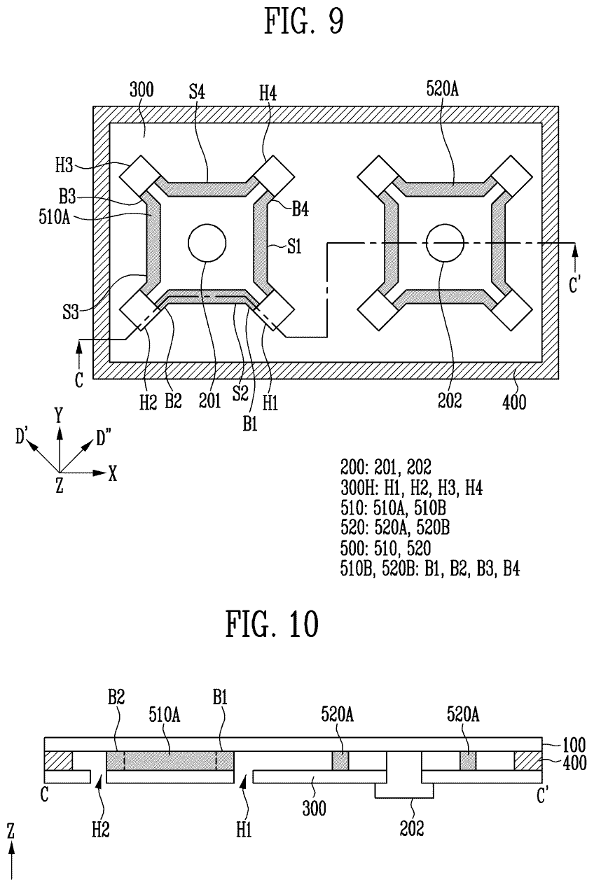

FIG. 9 is a plan view illustrating a display device in accordance with an embodiment of the disclosure. FIG. 10 is a schematic cross-sectional view taken along line C-C′ shown in FIG. 9.

Referring to FIGS. 9 and 10, in accordance with an embodiment of the disclosure, a second area 510B or 520B (or exhaust portion) of a baffle 500 and/or an opening 300H of a chassis 300 may be provided in plurality, and the second area 510B or 520B (or exhaust portion) of the baffle 500 may extend toward the opening 300H of the chassis 300.

The opening 300H of the chassis 300 may include first to fourth openings H1, H2, H3, and H4.

The first opening H1 may be adjacent to a first corner between a first side S1 and a second side S2 of a first area 510A or 520A of the baffle 500 in a plan view. The first corner may be a point at which the first side S1 and the second side S2 intersect each other in a plan view.

The second opening H2 may be adjacent to a second corner between the second side S2 and a third side S3 of the first area 510A or 520A of the baffle 500 in a plan view. The second corner may be a point at which the second side S2 and the third side S3 intersect each other in a plan view.

The third opening H3 may be adjacent to a third corner between the third side S3 and a fourth side S4 of the first area 510A or 520A of the baffle 500 in a plan view. The third corner may be a point at which the third side S3 and the fourth side S4 intersect each other in a plan view.

The fourth opening H4 may be adjacent to a fourth corner between the fourth side S4 and the first side S1 of the first area 510A or 520A of the baffle 500 in a plan view. The fourth corner may be a point at which the fourth side S4 and the first side S1 intersect each other in a plan view.

The second area 510B or 520B of the baffle 500 may include first to fourth exhaust portions B1, B2, B3, and B4. The first exhaust portion B1 may extend from the first corner between the first side S1 and the second side S2 of the first area 510A or 520A of the baffle 500 in a plan view. The first corner may be the point at which the first side S1 and the second side S2 intersect each other in a plan view. In an embodiment, the first exhaust portion B1 may extend toward the first opening H1 from the first corner in a plan view. The first exhaust portion B1 may extend in a third direction D′ intersecting the first direction (X-axis direction) and the second direction (Y-axis direction) or the opposite direction of the third direction D′in a plan view.

The second exhaust portion B2 may extend from the second corner between the second side S2 and the third side S3 of the first area 510A or 520A of the baffle 500 in a plan view. The second corner may be the point at which the second side S2 and the third side S3 intersect each other in a plan view. In an embodiment, the second exhaust portion B2 may extend toward the second opening H2 from the second corner in a plan view. The second exhaust portion B2 may extend in a fourth direction D″ intersecting the first direction (X-axis direction), the second direction (Y-axis direction), and the third direction D′ or the opposite direction of the fourth direction D″ in a plan view.

The third exhaust portion B3 may extend from the third corner between the third side S3 and the fourth side S4 of the first area 510A or 520A of the baffle 500 in a plan view. The third corner may be the point at which the third side S3 and the fourth side S4 intersect each other in a plan view. In an embodiment, the third exhaust portion B3 may extend toward the third opening H3 from the third corner in a plan view. The third exhaust portion B3 may extend in the third direction D′ or the opposite direction of the third direction D′in a plan view.

The fourth exhaust portion B4 may extend from the fourth corner between the fourth side S4 and the first side S1 of the first area 510A or 520A of the baffle 500 in a plan view. The fourth corner may be the point at which the fourth side S4 and the first side S1 intersect each other in a plan view. In an embodiment, the fourth exhaust portion B4 may extend toward the fourth opening H4 from the fourth corner in a plan view. The fourth exhaust portion B3 may extend along the fourth direction D″ or the opposite direction of the fourth direction D″ in a plan view.

Although an embodiment in which the second area 510B or 520B (or exhaust portion) of the baffle 500 and/or the opening 300H of the chassis 300 are/is configured with four exhaust portions and/or four openings is illustrated in FIGS. 9 and 10, the disclosure is not necessarily limited thereto, and the number, position, size, and the like of the second area 510B or 520B (or exhaust portion) of the baffle 500 and/or the opening 300H of the chassis 300 may be variously changed.

In the display device in accordance with the above-described embodiment, the second area 510B or 520B (or exhaust portion) of the baffle 500 and/or the opening 300H of the chassis 300 are/is provided in plurality, and the position and size thereof may be adjusted by considering a sound, a device structure, and the like, so that damping can be readily controlled, thereby improving sound characteristics of the display device.

In accordance with the disclosure, the display device may include the sound generating device 200 which generates a sound by vibrating the display panel 100, so that a sound may be output in the front direction of the display panel 100, thereby enhancing the immersion of a viewer watching an image.

In accordance with the disclosure, air between the display panel 100 and the chassis 300 may be exhausted to the outside through the opening 300H of the chassis 300 in case that a sound is output, so that damping may be controlled, thereby improving sound characteristics of the display device.

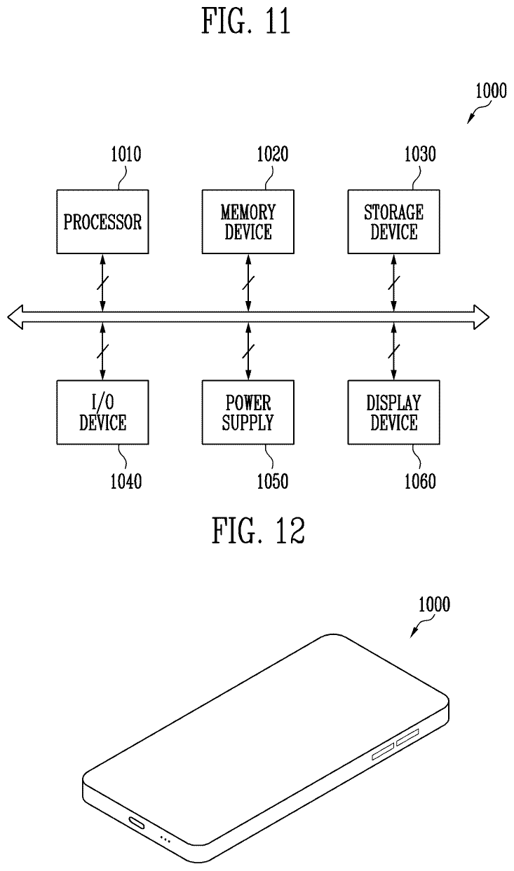

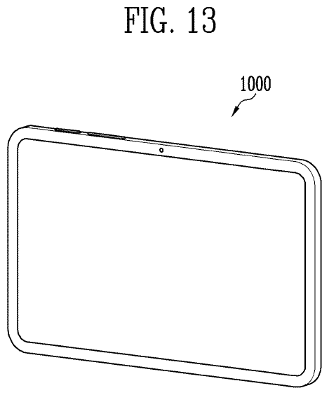

FIG. 11 is a schematic block diagram illustrating an electronic device 1000 including a display device in accordance with an embodiment. FIG. 12 is a schematic diagram illustrating an example where the electronic device 1000 of FIG. 11 is a smartphone. FIG. 13 is a schematic diagram illustrating an example where the electronic device 1000 of FIG. 11 is a tablet computer.

Referring to FIGS. 11 to 13, the electronic device 1000 may include a processor 1010, a memory device 1020, a storage device 1030, an input/output (I/O) device 1040, a power supply 1050, and a display device 1060. The display device 1060 may be the display device of FIG. 1. The electronic device 1000 may further include various ports for communication with a video card, a sound card, a memory card, a USB device, or other systems. In an embodiment, as illustrated in FIG. 12, the electronic device 1000 may be a smartphone. In an embodiment, as illustrated in FIG. 13, the electronic device 1000 may be a tablet computer. However, the aforementioned examples are illustrative, and the electronic device 1000 is not necessarily limited to the aforementioned examples. For example, the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. In an embodiment, the processor 1010 may include at least one of a central processing unit, an application processor, a graphic processing unit, a communication processor, an image signal processor, a controller, or the like. The processor 1010 may be connected to other components through an address bus, a control bus, a data bus, and the like. In an embodiment, the processor 1010 may be connected to an expansion bus such as a peripheral component interconnect (PCI) bus. In an embodiment, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device 1000. For example, the power supply 1050 may include a power management integrated circuit (PMIC). In an embodiment, the power supply 1050 may supply power to the display device 1060.

The display device 1060 may display images in response to image data signals and/or control signals from the processor 1010. The display device 1060 may be connected to other components through the buses or other communication links.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A display device comprising:
a display panel;
a sound generating device disposed on a rear surface of the display panel;
a chassis disposed on the rear surface of the display panel and including an opening; and
a baffle disposed between the display panel and the chassis and including an exhaust portion,
wherein the exhaust portion extends toward the opening.

2. The display device of claim 1, wherein the baffle surrounds the sound generating device in a plan view.

3. The display device of claim 1, wherein the sound generating device includes a first sound generating device and a second sound generating device, which are spaced apart from each other in a plan view.

4. The display device of claim 3, wherein the opening is disposed between the first sound generating device and the second sound generating device in a plan view.

5. The display device of claim 1, wherein the baffle comprises a first side extending in a first direction and a second side extending in a second direction intersecting the first direction in a plan view.

6. The display device of claim 5, wherein the exhaust portion extends in the second direction from the first side in a plan view.

7. The display device of claim 5, wherein the exhaust portion includes a first exhaust portion disposed at a first corner of the baffle at which the first side and the second side intersect each other in a plan view.

8. The display device of claim 7, wherein the opening includes a first opening adjacent to the first exhaust portion.

9. The display device of claim 7, wherein
the baffle further includes a third side facing the first side in a plan view, and
the exhaust portion further includes a second exhaust portion disposed at a second corner of the baffle at which the second side and the third side intersect each other in a plan view.

10. The display device of claim 9, wherein the opening includes a second opening adjacent to the second exhaust portion.

11. A display device comprising:
a display panel;
a sound generating device disposed on a rear surface of the display panel;
a chassis disposed on the rear surface of the display panel and including an opening; and
a baffle disposed between the display panel and the chassis,
wherein the baffle includes a first area surrounding the sound generating device in a plan view and a second area extending toward the opening from the first area.

12. The display device of claim 11, wherein a length of the first area is greater than a length of the second area in an extension direction of the second area.

13. The display device of claim 11, wherein the first area includes a first side extending in a first direction and a second side extending in a second direction intersecting the first direction in a plan view.

14. The display device of claim 13, wherein the second area extends in the second direction from the first side in a plan view.

15. The display device of claim 13, wherein the second area includes a first exhaust portion extending from a first corner of the first area at which the first side and the second side intersect each other in a plan view.

16. The display device of claim 15, wherein the first exhaust portion extends in a third direction intersecting the first direction and the second direction in a plan view.

17. The display device of claim 15, wherein
the first area further includes a third side facing the first side in a plan view, and
the second area further includes a second exhaust portion extending from a second corner of the first area at which the second side and the third side intersect each other in a plan view.

18. The display device of claim 17, wherein the second exhaust portion extends in a fourth direction intersecting the first direction and the second direction in a plan view.

19. The display device of claim 11, wherein the sound generating device includes a first sound generating device and a second sound generating device, which are spaced apart from each other in a plan view.

20. The display device of claim 19, wherein the opening is disposed between the first sound generating device and the second sound generating device in a plan view.

21. An electronic device comprising:
a processor to provide input image data; and
a display device to display an image based on the input image data, the display device including sub-pixel areas,
wherein the display device comprises:
a display panel;
a sound generating device disposed on a rear surface of the display panel;
a chassis disposed on the rear surface of the display panel and including an opening; and
a baffle disposed between the display panel and the chassis and including an exhaust portion,
wherein the exhaust portion extends toward the opening.
